(19) United States
(12) Patent Application Publication
(10) Pub. No.: US 2025/0216757 A1
(43) Pub. Date: Jul. 3, 2025

(54) PROJECTION DISPLAY DEVICE

(71) Applicant: SEIKO EPSON CORPORATION, Tokyo (JP)

(72) Inventor: Kazuhisa MIZUSAKO, Shiojiri-shi (JP)

(73) Assignee: SEIKO EPSON CORPORATION, Tokyo (JP)

(21) Appl. No.: 19/002,293

(22) Filed: Dec. 26, 2024

(30) Foreign Application Priority Data
Dec. 27, 2023 (JP) 2023-220618

(51) Int. Cl. G03B 21/20; G03B 21/00

(52) U.S. Cl. CPC G03B 21/2013; G03B 21/006; G03B 21/2033; G03B 21/2073

(57) ABSTRACT

A projection display device includes a first light emission device that emits a first image light, a second light emission device that emits a second image light, a prism that combines the first image light and the second image light, a position adjustment element that shifts the light path of the first image light, a light path shift element that shifts the light path of a combined image light from the prism, and a display control circuit. In an odd-numbered field period, the display control circuit supplies to the first light emission device a data signal of odd-numbered rows and supplies to the second light emission device a data signal of even-numbered rows. In the even-numbered field period, the display control circuit supplies to the first light emission device a data signal of even-numbered rows, and supplies to the second light emission device a data signal of even-numbered rows.

The present application is based on, and claims priority from JP Application Serial Number 2023-220618, filed Dec. 27, 2023, the disclosure of which is hereby incorporated by reference herein in its entirety.

### BACKGROUND

### 1. Technical Field

The present disclosure relates to a projection display device.

### 2. Related Art

In a projection display device that projects image light created by a liquid crystal panel or the like onto a screen or the like, a technology for shifting a first optical image generated by a first optical system and a second optical image generated by a second optical system, combining the optical images, and projecting a resultant image to achieve high resolution has been proposed (see, for example, JP-A-2010-181670).

Specifically, the following configuration is employed when color display is implemented in the above-mentioned technology. That is, images from three liquid crystal panels are combined by a first dichroic prism to obtain a first optical image in the first optical system, images from three liquid crystal panels are combined by a second dichroic prism to obtain a second optical image in the second optical system, and the first optical image and the second optical image are combined by a prism.

The above-described technology, however, requires not only a total of six liquid crystal panels, but also three prisms for combining the optical images. Realizing a high-resolution color display with the above-described technology increases the complexity of the configuration and also leads to higher costs.

### SUMMARY

To solve the above-mentioned problems, a projection display device according to an aspect of the present disclosure includes a first image light emission device configured to emit first image light, a second image light emission device configured to emit second image light, an optical combination system configured to combine, and emit as composite light, the first image light and the second image light in a state where the second image light is shifted in a first direction with respect to the first image light, a first light path shift element provided between the first image light emission device and the optical combination system, and configured to shift a light path of the first image light emitted from the first image light emission device, a second light path shift element configured to shift a light path of the composite light emitted from the optical combination system, and a display control circuit configured to control the first image light emission device, the second image light emission device, the first light path shift element, and the second light path shift element. Video pixel data making up video data is arranged along the first direction and a second direction intersecting the first direction, a one-frame period includes a first field period and a second field period, in the first field period, the display control circuit supplies to the first image light emission device a data signal of a video pixel that is odd-numbered in the second direction and is odd-numbered in the first direction in the arrangement, and supplies to the second image light emission device a data signal of a video pixel that is odd-numbered in the second direction and is even-numbered in the first direction in the arrangement, in the second field period, the display control circuit supplies to the first image light emission device a data signal of a video pixel that is even-numbered in the second direction and is odd-numbered in the first direction in the arrangement, and supplies to the second image light emission device a data signal of a video pixel that is even-numbered in the second direction and is even-numbered in the first direction in the arrangement, the display control circuit controls the second light path shift element to shift the light path in the second direction from a position of the first field, the first image light emission device emits the first image light based on supplied data signal, and the second image light emission device emits the second image light based on supplied data signal.

### BRIEF DESCRIPTION OF THE DRAWINGS

FIG. 1 is a diagram illustrating a projection display device according to an embodiment.

FIG. 2 is a block diagram illustrating a configuration of the projection display device.

FIG. 3 is a diagram illustrating an arrangement of video pixels in the projection display device.

FIG. 4 is a diagram illustrating an arrangement of panel pixels in the projection display device.

FIG. 5 is a perspective view illustrating a configuration of a liquid crystal panel in the projection display device.

FIG. 6 is a cross-sectional view illustrating the structure of a liquid crystal panel.

FIG. 7 is a block diagram illustrating an electrical configuration of the liquid crystal panel.

FIG. 8 is a diagram illustrating a configuration of a pixel circuit in the liquid crystal panel.

FIG. 9 is a diagram illustrating an operation in a one-frame period of the projection display device.

FIG. 10 is a diagram illustrating a writing operation in the liquid crystal panel.

FIG. 11 is a diagram illustrating a relationship between video pixels, panel pixels, and projection positions in a one-frame period.

FIG. 12 is a diagram illustrating a configuration of a position adjustment element.

FIG. 13 is a diagram for describing a shift by means of the position adjustment element.

FIG. 14 is a diagram for describing a shift by means of the position adjustment element.

FIG. 15 is a diagram for describing position adjustment by means of the position adjustment element.

FIG. 16 is a diagram illustrating a projection display device according to a second modification.

FIG. 17 is a diagram illustrating a projection display device according to a third modification.

FIG. 18 is a diagram illustrating a projection display device according to a fourth modification.

FIG. 19 is a diagram illustrating a projection display device according to a fifth modification.

### DESCRIPTION OF EMBODIMENTS

Hereinafter, a projection display device according to an embodiment will be described with reference to the drawings. In each drawing, dimensions and scales of each portion are appropriately different from actual ones. Further, since embodiments to be described below are preferred specific examples, various technically preferable limitations are applied, but the scope of the present disclosure is not limited to these embodiments unless it is otherwise stated in the following description that the present disclosure is limited.

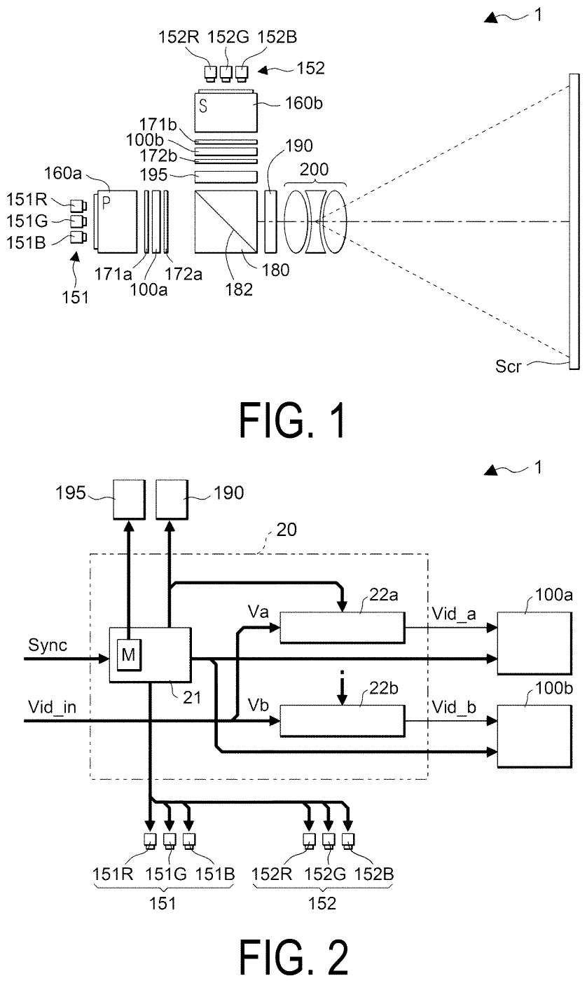

FIG. 1 is a diagram illustrating an optical configuration of a projection display device 1 according to an embodiment. The projection display device 1 includes liquid crystal panels 100a and 100b, light sources 151 and 152, optical polarization systems 160a and 160b, a prism 180, a light path shift element 190, a position adjustment element 195 and a projection lens 200.

The light source 151 includes laser light sources 151R, 151G, and 151B. Among the laser light sources 151R, 151G, and 151B, the laser light source 151R emits light including a red wavelength range, the laser light source 151G emits light including a green wavelength range, and the laser light source 151B emits light including a blue wavelength range.

The optical polarization system 160a diffuses the light emitted from the laser light sources 151R, 151G, and 151B, forms the light into a substantially parallel light beam with a substantially uniform illuminance, converts the light beam to P-polarized light, and emits the P-polarized light toward the transmissive liquid crystal panel 100a. The conversion to the P-polarized light also includes transmitting the P-polarized light. A polarization plate 171a is provided between an emission surface of the optical polarization system 160a and an incidence surface of the liquid crystal panel 100a, and a polarization plate 172a is provided on an emission surface of the liquid crystal panel 100a.

A transmission axis of the polarization plate 171a is P-polarized light, and a transmission axis of the polarization plate 172a is S-polarized light. As such, a P-polarized light component not modulated by the liquid crystal panel 100a is blocked by the polarization plate 172a.

The light source 152 includes laser light sources 152R, 152G, and 152B, as with the light source 151. Among the laser light sources 152R, 152G, and 152B, the laser light source 152R emits light including a red wavelength range, the laser light source 152G emits light in a green wavelength range, and the laser light source 152B emits light in a blue wavelength range.

The optical polarization system 160b diffuses the light emitted from the laser light sources 152R, 152G, and 152B, forms the light into a substantially parallel light beam with a substantially uniform illuminance, converts the light beam into S-polarized light, and emits the S-polarized light toward the transmissive liquid crystal panel 100b. The conversion to the S-polarized light also includes transmitting the S-polarized light. A polarization plate 171b is provided between an emission surface of the optical polarization system 160b and an incidence surface of the liquid crystal panel 100b, and a polarization plate 172b is provided on an emission surface of the liquid crystal panel 100b.

A transmission axis of the polarization plate 171b is S-polarized light, and a transmission axis of the polarization plate 172b is P-polarized light. To this end, an S-polarized light component not modulated by the liquid crystal panel 100b is blocked by the polarization plate 172b.

The liquid crystal panels 100a and 100b include a plurality of pixel circuits, as will be described below. Each of the plurality of pixel circuits includes a liquid crystal element. A liquid crystal element of the liquid crystal panel 100a is driven based on a data signal supplied from a display control circuit, and modulates incident light according to a voltage of the data signal. This modulation changes an amount of light passing through the polarization plate 172a, that is, changes transmittance. Thus, by individually controlling the modulation in the liquid crystal elements on the basis of the data signal, a transmission image is generated in the liquid crystal panel 100a. Similarly, a transmission image is generated in the liquid crystal panel 100b.

The position adjustment element 195 shifts the light path of the transmission image of the liquid crystal panel 100b and emits it toward the prism 180. While the position adjustment element 195 will be elaborated later, the position adjustment element 195 shifts the light path of the transmission image of the liquid crystal panel 100b in the left-right direction and up-down direction with respect to the arrangement of the panel pixels. Specifically, the position adjustment element 195 can shift the light path of the transmission image in two axes. The shift of the light path by the position adjustment element 195 is only one time, immediately after the power is turned on.

The transmission image from the liquid crystal panel 100a impinges on the prism 180 from the 9 o'clock direction in FIG. 1, and the transmission image from the liquid crystal panel 100b impinges on the prism 180 from the 12 o'clock direction. At a joint surface 182 of the prism 180, the S-polarized light of the transmission image from the liquid crystal panel 100a passes and travels straight, and the P-polarized light of the transmission image from the liquid crystal panel 100b is reflected.

Therefore, the transmission image from the liquid crystal panel 100a and the transmission image from the liquid crystal panel 100b are combined in the prism 180, and a composite image is emitted in the 3 o'clock direction. The composite image from the prism 180 impinges on the projection lens 200 via the light path shift element 190.

The projection lens 200 enlarges and projects the composite image passed through the light path shift element 190 onto the screen Scr.

The light path shift element 190 shifts the light path of the light emitted from the prism 180, and shifts the composite image projected on the screen Scr in the up-down direction with respect to the projection surface in the embodiment.

At the joint surface 182 of the prism 180, the transmission image from the liquid crystal panel 100a travels straight, whereas the transmission image from the liquid crystal panel 100b is reflected. Thus, the transmission image from the liquid crystal panel 100b is generated in a horizontally inverted manner with respect to the transmission image from the liquid crystal panel 100a Further, the transmission image from the liquid crystal panel 100a and the transmission image from the liquid crystal panel 100b are mismatched in pixels and therefore are combined in a shifted state, as will be described below.

FIG. 2 is a block diagram illustrating an electrical configuration of the projection display device 1. As illustrated in the drawing, the projection display device 1 includes a display control circuit 20, in addition to the liquid crystal panels 100a and 100b, the light sources 151 and 152, the light path shift element 190 and the position adjustment element 195 described above.

Video data Vid in is supplied from an upper device such as a host device (not illustrated) in synchronization with a synchronization signal Sync. The video data Vid in designates a gradation level of pixels in an image constituting one-frame period of a video, for example, in 8 bits for each RGB.

The pixels of the image designated by the video data Vid in are referred to as video pixels, and data for designating the gradation level of the video pixel is referred to as video pixel data, but the video pixel and the video pixel data may not be specifically distinguished. Further, a pixel of an image before or after combined at the liquid crystal panel 100a or 100b is referred to as a panel pixel. A position of the panel pixel shifted by the light path shift element 190 and projected onto the screen Scr is referred to as a projection position.

In the liquid crystal panels 100a and 100b, panel pixels corresponding to the pixel circuits are arranged in a matrix in a plan view. In the embodiment, an arrangement of the video pixels designated by the video data Vid in is, for example, twice as large in a vertical direction and twice as large in a horizontal direction as an arrangement of the panel pixels from the liquid crystal panel 100a or 100b.

The synchronization signal Sync includes a vertical synchronization signal for instructing the start of vertical scanning of the video data Vid in, a horizontal synchronization signal for instructing the start of horizontal scanning, and a clock signal indicating a timing for one video pixel in the video data Vid in.

The display control circuit 20 includes a processing circuit 21 and conversion circuits 22a and 22b.

The processing circuit 21 controls the position adjustment element 195 in the initialization process immediately after power-on. In the image projection process after the initialization process, the processing circuit 21 controls the conversion circuits 22a and 22b and the liquid crystal panels 100a and 100b for each writing period described later on the basis of the synchronization signal Sync, and controls the light sources 151 and 152 and the light path shift element 190 for each field period described later.

In the initialization process, the position adjustment element 195 shifts the transmission image of the liquid crystal panel 100b in accordance with the position data, and causes it to impinge on the prism 180. The position data is stored in a memory element M of the processing circuit 21 before shipment from the factory. Once the light path is shifted by the position adjustment element 195 in the initialization process, the light path is fixed thereafter, but when the power is shut off, it is restored to the state before the shift.

In the image projection process, the light path shift element 190 shifts the projection position for each field period under the control of the processing circuit 21.

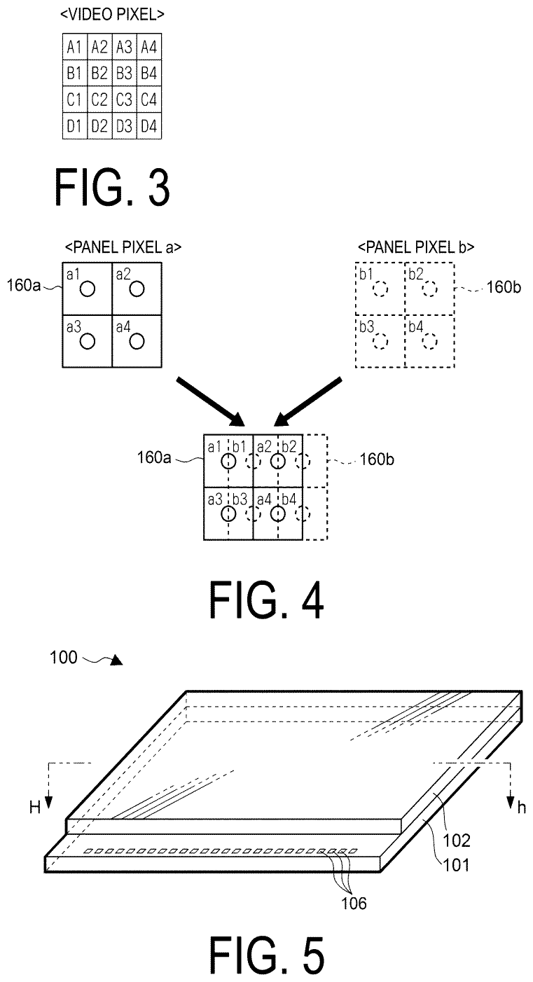

FIG. 3 is a diagram illustrating a part of an arrangement of video pixels represented by the video data Vid in.

In the figure, A1 to A4 are assigned as symbols in a first row, B1 to B4 in a second row, C1 to C4 in a third row, and D1 to D4 in a fourth row, for convenience, in order to distinguish the video pixels in the video represented by the video data Vid in.

The description will return to FIG. 2. In the video data Vid in, video pixel data for designating a gradation level of the video pixel represented by the liquid crystal panel 100a is indicated by Va, and video pixel data for designating a gradation level of the video pixel represented by the liquid crystal panel 100b is indicated by Vb.

The conversion circuit 22a temporarily stores the video pixel data Va for one or more frame periods in an internal buffer, reads video pixel data of a color component corresponding to a writing period, converts the video pixel data into an analog voltage data signal Vid a having a polarity corresponding to the writing period, and supplies the data signal to the liquid crystal panel 100a.

The conversion circuit 22b is different from the conversion circuit 22a only in the video pixel data to convert, and is the same as the conversion circuit 22a in other respects. That is, the conversion circuit 22b temporarily stores the video pixel data Vb, reads the video pixel data of the color component corresponding to the writing period, converts the video pixel data into an analog voltage data signal Vid_b having a polarity corresponding to the writing period, and supplies the data signal to the liquid crystal panel 100b.

A gradation level of which video pixel designated by the video pixel data Va and Vb will be described later.

FIG. 4 is a diagram illustrating the panel pixels corresponding to the arrangement of the video pixels in FIG. 3 among the panel pixels of the liquid crystal panel 100a and the panel pixels of the liquid crystal panel 100b.

For convenience of description, the panel pixels of the liquid crystal panel 100a are indicated as panel pixels a, and the panel pixels of the liquid crystal panel 100b are indicated as panel pixels b.

In the arrangement on the left side, a1 and a2 are assigned in the first row and a3 and a4 are assigned in the second row as symbols for convenience in order to distinguish the panel pixels a, and in the arrangement on the right side, b1 and b2 are assigned in the first row and b3 and b4 are assigned in the second row as symbols for convenience in order to distinguish the panel pixels b.

As will be described later, in the liquid crystal panels 100a and 100b, a microlens is provided in each panel pixel in order to improve the efficiency of light use. As such, the brightness of the panel pixel is not uniform in plan view, and in reality, the panel pixel is bright near a center of the panel pixel and becomes darker as it goes toward the outside from the vicinity of the center. In the figure, circles of the panel pixels a and b simply indicate portions that become brighter than other portions due to light collection in the microlens. The center of the circle substantially coincides with a diagonal center of the panel pixel a or b.

The arrangement of the panel pixels a and b with respect to the prism 180 has a relationship illustrated in the lower section in FIG. 4 after the shift of the light path by means of the position adjustment element 195. In detail, the arrangement of the panel pixels b is shifted in the right direction in the figure by 0.5 pixels of the panel pixel with respect to the arrangement of the panel pixels a. Specifically, the center of the panel pixel b1 is located between the center of the panel pixel a1 and the center of the panel pixel a2, and the center of the panel pixel b3 is located between the center of the panel pixel a3 and the center of the panel pixel a4.

Next, the liquid crystal panels 100a and 100b will be described.

The liquid crystal panels 100a and 100b are different in only data signals to be supplied, and are the same in a structure. Therefore, the liquid crystal panels 100a and 100b will be generally described using 100 as a reference sign without any one of the liquid crystal panels 100a and 100b being specified.

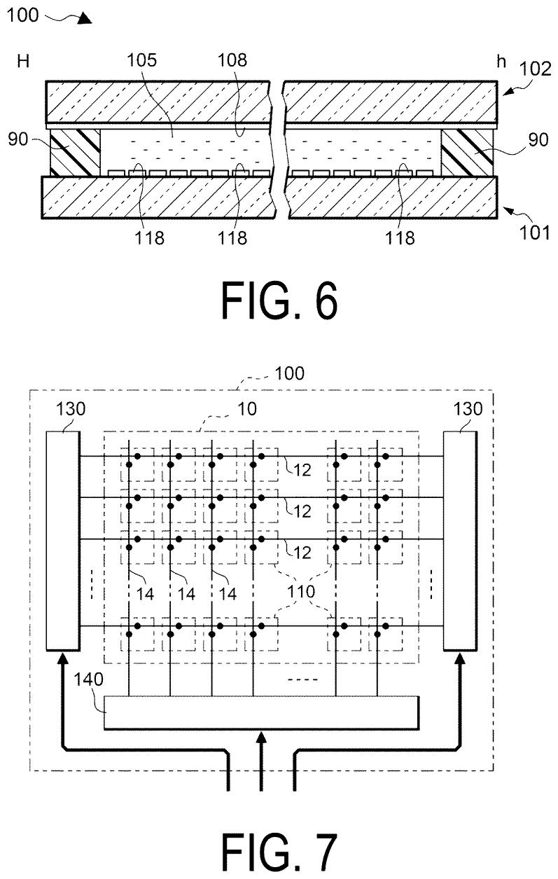

FIG. 5 is a perspective view of the liquid crystal panel 100, and FIG. 6 is a cross-sectional view taken along a line H-h in FIG. 5.

As illustrated in these figures, in the liquid crystal panel 100, an element substrate 101 on which pixel electrodes 118 are provided and a counter substrate 102 on which a common electrode 108 is provided are bonded by a seal material 90 so that electrode formation surfaces face each other while maintaining a certain gap, and this gap is filled with a liquid crystal 105.

As the element substrate 101 and the counter substrate 102, optically transparent substrates of glass, quartz or the like are used. As illustrated in FIG. 5, one side of the element substrate 101 protrudes from the counter substrate 102. In this protruding area, a plurality of terminals 106 are provided along a horizontal direction in FIG. 5. One end of a flexible printed circuit (FPC) substrate (not illustrated) is coupled to the plurality of terminals 106. The other end of the FPC substrate is coupled to the display control circuit 20, and the above-described various signals are supplied.

On the surface of the element substrate 101 facing the counter substrate 102, the pixel electrodes 118 are provided by patterning a transparent conductive layer such as indium tin oxide (ITO).

Further, although not illustrated, a microlens is provided in each panel pixel on the counter substrate 102 (or the element substrate 101) in order to efficiently send a large amount of light to an opening that becomes the panel pixel. With this configuration, light blocked by a light shielding portion is sent to an opening of the microlens, thereby improving the efficiency of light use. The light shielding portion is provided to determine an outer edge of the panel pixels or to prevent light leakage in the transistor.

FIG. 7 is a block diagram illustrating an electrical configuration of the liquid crystal panel 100. The liquid crystal panel 100 is provided with a scanning line driving circuit 130 and a data line driving circuit 140 on a periphery of the display area 10.

In the display area 10, pixel circuits 110 are arranged in a matrix. In detail, in the display area 10, a plurality of scanning lines 12 are provided to extend in a horizontal direction in the figure, and a plurality of data lines 14 are provided to extend in a vertical direction and to be electrically insulated from the scanning lines 12. The pixel circuits 110 are provided in a matrix to correspond to intersections between the plurality of scanning lines 12 and the plurality of data lines 14.

When the number of scanning lines 12 is m and the number of data lines 14 is n, the pixel circuits 110 are arranged in a matrix of m vertical rows and n horizontal columns. Both m and n are integers equal to or equal to 2. In order to distinguish the rows of the matrix in the scanning lines 12 and the pixel circuits 110, the rows may be referred to as 1, 2, 3, . . . , (m-1), mth row in order from the top in the figure. Similarly, in order to distinguish the columns of the matrix in the data lines 14 and the pixel circuits 110, the columns may be referred to as 1, 2, 3, . . . , (n-1), nth column in order from the left in the figure.

Since the video pixels are arranged twice as large a vertical direction and twice as large in a horizontal direction as the arrangement of the panel pixels, the arrangement of the video pixels is (2m) rows (2n) columns.

The “row” and “column” are relative concepts, in which when one of the horizontal (left and right) direction and the vertical (upper and lower) direction is set to “row”, the other of the horizontal direction and vertical direction is “line”. However, in this description, for convenience, the horizontal direction in which the scanning line 12 extends is referred to as the “row”, and the vertical direction in which the data line 14 extends is referred to as the “column”.

The odd number and even number are also relative concepts, in which when odd numbers are set in one of the horizontal direction and the vertical direction, even numbers are the numbers other than the odd numbers in the other of the horizontal direction and the vertical direction.

Further, an integer i of 1 or more and m or less may be used to generally describe the rows of the scanning lines 12, the panel pixels, or the video pixels. Further, an integer j of 1 or more and n or less may be used to generally describe the columns of the data lines 14, the panel pixels, or the video pixels.

The scanning line driving circuit 130 selects the scanning lines 12 one by one in order of, for example, the first, second, third, . . . , mth rows under the control of the display control circuit 20, and sets a scanning signal to the selected scanning line 12 to a H level. The scanning line driving circuit 130 sets a scanning signal to the scanning lines 12 other than the selected scanning line 12 to a L level.

The data line driving circuit 140 outputs a data signal supplied from the corresponding conversion circuit 22a or 22b to the pixel circuits 110 of the columns 1 to n located on the scanning line 12 via the data line 14 in a period in which the scanning signal to the scanning line 12 has reached the H level.

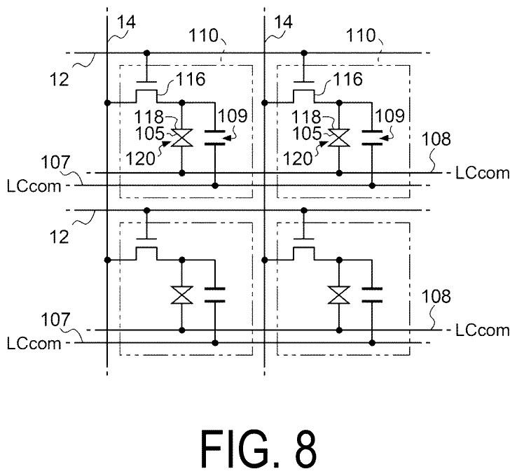

FIG. 8 is a diagram illustrating an equivalent circuit of a total of four pixel circuits 110 of two vertical rows and two horizontal columns corresponding to the intersections of two adjacent scanning lines 12 and two adjacent data lines 14.

As illustrated in FIG. 8, the pixel circuit 110 includes a transistor 116 and a liquid crystal element 120. The transistor 116 is, for example, an n-channel thin film transistor. In the pixel circuit 110, the transistor 116 has a gate node coupled to the scanning line 12, a source node coupled to the data line 14, and a drain node coupled to the pixel electrode 118 having a square shape in a plan view.

The common electrode 108 is provided in common to all the pixels to face the pixel electrode 118. A voltage LCcom is applied to the common electrode 108. As described above, the liquid crystal 105 is sandwiched between the pixel electrodes 118 and the common electrode 108. Therefore, the liquid crystal element 120 in which the liquid crystal 105 is sandwiched between the pixel electrodes 118 and the common electrode 108 is formed in each pixel circuit 110.

Further, a storage capacitor 109 is provided in parallel with the liquid crystal element 120. The storage capacitor 109 has one terminal coupled to the pixel electrode 118, and the other terminal coupled to a capacitance line 107. A voltage that is constant over time such as the voltage LCcom that is the same as the voltage applied to the common electrode 108 is applied to the capacitance line 107. Since the pixel circuits 110 are arranged in a matrix in a horizontal direction which is a direction in which the scanning lines 12 extend and a vertical direction which is a direction in which the data lines 14 extend, the pixel electrodes 118 included in the pixel circuits 110 are also arranged in a matrix in the vertical direction and the horizontal direction.

In the scanning line 12 on which the scanning signal has reached the H level, the transistor 116 of the pixel circuit 110 provided to correspond to the scanning line 12 enters an on state. Since the data line 14 and the pixel electrode 118 are electrically coupled when the transistor 116 enters the on state, the data signal supplied to the data line 14 reaches the pixel electrode 118 through the transistor 116 that has entered the on state. When the scanning line 12 becomes at the L level, the transistor 116 enters an off state, but a voltage of the data signal that has reached the pixel electrode 118 is held by a capacitance of the liquid crystal element 120 and the storage capacitor 109.

As is well known, in the liquid crystal element 120, the orientation of liquid crystal molecules changes depending on the electric field generated by the pixel electrode 118 and the common electrode 108. Therefore, the liquid crystal element 120 has a transmittance according to an effective value of an applied voltage.

An area of the liquid crystal element 120 functioning as a panel pixel, that is, an area having a transmittance according to the effective value of the voltage is an area where the pixel electrode 118 and the common electrode 108 overlap when the element substrate 101 and the counter substrate 102 are viewed in plan. Since the pixel electrode 118 has the square shape in plan view, a shape of the panel pixel of the liquid crystal panel 100 is also a square shape.

Further, in the present embodiment, the liquid crystal 105 is of a vertical alignment (VA) type, and is in a normally black mode in which a transmittance is lowest when a voltage applied to the liquid crystal element 120 is zero, and increases as the applied voltage increases.

A writing operation for supplying the data signal to the pixel electrode 118 of the liquid crystal element 120 is executed in order of the first, second, third, . . . , mth rows. Accordingly, a voltage corresponding to the data signal is held in each of the liquid crystal elements 120 of the pixel circuits 110 arranged in m rows n columns, each liquid crystal element 120 has a desired transmittance, and a transmission image is generated by the liquid crystal elements 120 arranged in m rows n columns.

Since application of a DC voltage to the liquid crystal element 120 deteriorates the liquid crystal 105, a positive voltage and a negative voltage are applied alternately to the pixel electrode 118 of the liquid crystal element 120. That is, the liquid crystal element 120 is driven by an AC voltage. A reference of the polarity is generally the voltage LCcom applied to the common electrode 108. A case where a data signal higher than the voltage LCcom is applied to the pixel electrode 118 is called positive polarity writing, and a case where a data signal lower than the voltage LCcom is applied is called negative polarity writing. The reference of the polarity may be a voltage different from the voltage LCcom in consideration of push-down of the transistor 116.

As described above, when the combination is performed by the prism 180, the arrangement of the panel pixels b is shifted with respect to the arrangement of the panel pixels a by the 0.5 pixels of the panel pixel in the right direction. As such, in the composite image of the transmission images of the liquid crystal panels 100a and 100b, the panel pixels are arranged in m rows and (2n) columns.

Since the video pixels of the image designated by the video data Vid in are arranged in (2m) rows and (2n) columns, the composite image lacks resolution in the vertical direction (column direction).

In view of this, the following describes an operation for doubling the resolution in the vertical direction of a composite image and causing such an image to be visually recognized.

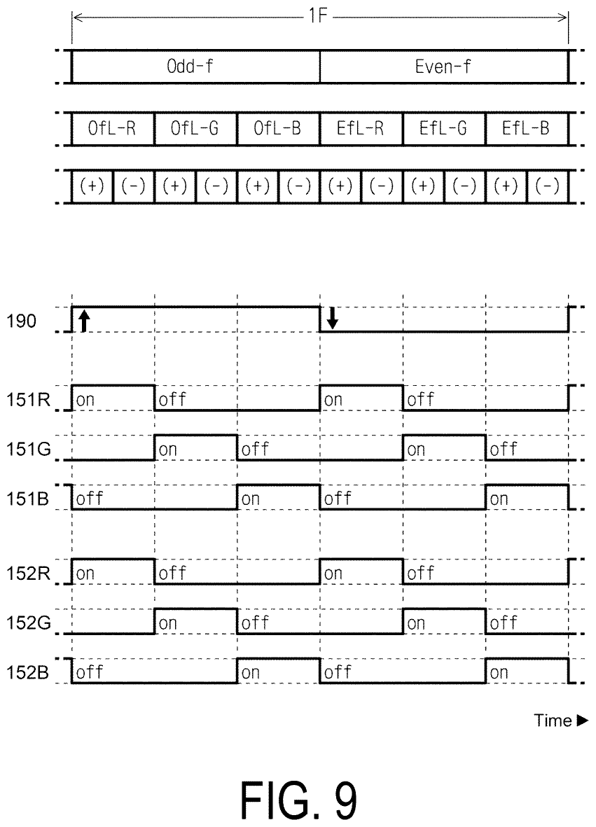

FIG. 9 is a diagram for describing an operation of the projection display device 1 according to the embodiment.

As shown in the figure, in the present embodiment, one frame period (1F) is divided into an odd-numbered field period (Odd-f) that is earlier in time and an even-numbered field period (Even-f) that is later in time. The one-frame period (1F) is a period in which one frame of the video represented by the video data Vid in is supplied, and is 16.7 milliseconds of one cycle when a frequency of the vertical synchronization signal included in the synchronization signal Sync is 60 Hz.

In the embodiment, the odd-numbered field period (Odd-f) is a period in which the panel pixel a of the liquid crystal panel 100a represents a video pixel in the odd-numbered row and the odd-numbered column, and the panel pixel b of the liquid crystal panel 100b represents a video pixel in the odd-numbered row and the even-numbered column. In other words, the odd-numbered field period (Odd-f) is a period in which the video pixel in the odd-numbered row is represented by a composite image of the panel pixels a and b.

Further, in the odd-numbered field period (Odd-f), the data signal Vid a supplied to the liquid crystal panel 100a by the conversion circuit 22a corresponds to the gradation level of the video pixel located in the odd-numbered row and the odd-numbered column. Further, in the odd-numbered field period (Odd-f), the data signal Vid_b supplied to the liquid crystal panel 100b by the conversion circuit 22b corresponds to the gradation level of the video pixel located in the odd-numbered row and the even-numbered column.

The even-numbered field period (Even-f) is a period in which the panel pixel a of the liquid crystal panel 100a represents the video pixel in the even-numbered row and the odd-numbered column, and the panel pixel b of the liquid crystal panel 100b represents the video pixel in the even-numbered row and the even-numbered column. In other words, the even-numbered field period (Even-f) is a period in which the video pixels in the even-numbered rows are represented by the composite image of the panel pixels a and b.

In the even-numbered field period (Even-f), the data signal Vid a supplied to the liquid crystal panel 100a by the conversion circuit 22a corresponds to the gradation level of the video pixel located in the even-numbered row and the odd-numbered column. Further, in the even-numbered field period (Even-f), the data signal Vid_b supplied to the liquid crystal panel 100b by the conversion circuit 22b corresponds to the gradation level of the video pixel located in the even-numbered row and the even-numbered column.

Specifically, in the embodiment, in the odd-numbered field period (Odd-f), the panel pixel a in row i and column j represents the video pixel in row (21-1) and column (2j-1), and the panel pixel b in row i and column j represents the video pixel in row (21-1) and column (2j).

Further, in the even-numbered field period (Even-f), the panel pixel a in row i and column j represents the video pixel in row (21) and column (2j-1), and the panel pixel b in row i and column j represents the video pixel in row (21) and column (2j).

(21-1) and (2j-1) are both odd numbers, and (21) and (2j) are both even numbers.

When the panel pixel “represents” a certain video pixel, this means a state in which the liquid crystal element 120 of the panel pixel has a transmittance corresponding to the gradation level (video pixel data) of the video pixel.

Further, when one frame period (1F) is 16.7 milliseconds, the odd-numbered field period (Odd-f) and the even-numbered field period (Even-f) are ½ thereof, 8.33 milliseconds.

In the embodiment, the video pixel data Va supplied to the conversion circuit 22a designates the gradation level of the video pixel located in the odd-numbered row and odd-numbered column in the odd-numbered field period (Odd-f), and designates the gradation level of the video pixels located in the odd-numbered rows and the even-numbered columns in the even-numbered field period (Even-f). The video pixel data Vb supplied to the conversion circuit 22b designates the gradation level of the video pixel located in the even-numbered row and the odd-numbered column in the odd-numbered field period (Odd-f), and designates the gradation level of the video pixels located in the even-numbered rows and the even-numbered columns in the even-numbered field period (Even-f).

The odd-numbered field period (Odd-f) is further divided into three unit periods, and in each unit period, one panel pixel individually represents the RGB components of the corresponding video pixel. That is, in the three unit periods of the odd-numbered field period (Odd-f), one panel pixel represents the RGB components of the video pixel in color sequence, that is, color in a time-division manner.

A period in the odd-numbered field period (Odd-f) in which the panel pixel represents the R component of the video pixel in the odd-numbered row is called OfL-R, a period in which the panel pixel represents the G component is called OfL-G, and a period in which the panel pixel represents the B component is called OfL-B.

Similarly, the even-numbered field period (Even-f) is divided into three periods including a unit period (EfL-R) in which the panel pixel represents the R component of the video pixel in the even-numbered row, a unit period (period EfL-G) in which the panel pixel represents the G component, and a period (EfL-B) in which the panel pixel represents the B component.

When the odd-numbered field period (Odd-f) and the even-numbered field period (Even-f) are 8.33 milliseconds, the unit periods (OfL-R, OfL-G, OfL-B, EfL-R, EfL-G, and EfL-B) are ⅓ thereof, 2.78 milliseconds.

Further, each of the unit periods (OfL-R, OfL-G, OfL-B, EfL-R, EfL-G, and EfL-B) is further divided into a writing period (+) for writing a positive polarity data signal and a writing period (−) for writing a negative polarity data signal.

In the embodiment, the processing circuit 21 controls the light path shift element 190 as follows. When the projection position in the odd-numbered field period (Odd-f) is set to the reference position, the processing circuit 21 shifts the projection position in a downward direction by 0.5 pixels of the panel pixel in the even-numbered field period (Even-f). When the even-numbered field period (Even-f) ends, the processing circuit 21 controls the light path shift element 190 so that the projection position is shifted in an upward direction by 0.5 pixels of the panel pixel in the odd-numbered field period and is returned to the reference position.

The downward direction is a vertical scanning direction, that is, a direction in which the scanning lines 12 are selected in order, and is, for example, a direction from the panel pixel a1 to a3 in FIG. 4. Further, in FIG. 9, when the control signal to the light path shift element 190 is at the H level, the projection position is the reference position, and when the control signal is at the L level, the projection position is shifted in the downward direction by the 0.5 pixels of the panel pixel from the reference position.

The processing circuit 21 controls the light sources 151 and 152 as follows.

In detail, first, the processing circuit 21 controls the laser light sources 151R and 152R so that the laser light sources 151R and 152R enter the on state and controls the other laser light sources so that the other laser light sources enter the off state in the unit period (OfL-R) of the odd-numbered field period (Odd-f) and the unit period (EfL-R) of the even-numbered field period (Even-f).

The on state in the laser light source refers to a state in which the laser light source emits light, and the off state in the laser light source refers to a state in which the laser light source does not emit light.

Second, the processing circuit 21 controls the laser light sources 151G and 152G so that the laser light sources 151G and 152G enter the on state, and controls the other laser light sources so that the other laser light sources enter the off state in the unit period (OfL-G) of the odd-numbered field period (Odd-f) and the unit period (EfL-G) of the even-numbered field period (Even-f).

Third, the processing circuit 21 controls the laser light sources 151B and 152B so that the laser light sources 151B and 152B enter the on state, and controls the other laser light sources so that the other laser light sources enter the off state in the unit period (OfL-B) of the odd-numbered field period (Odd-f) and the unit period (EfL-B) of the even-numbered field period (Even-f).

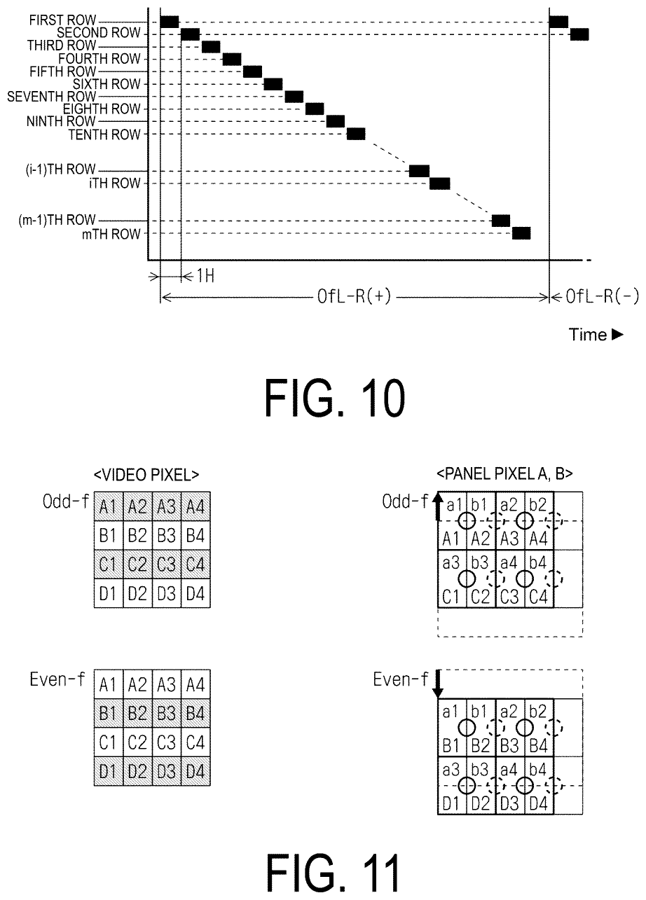

FIG. 10 is a diagram illustrating a time transition of the scanning lines 12 to be selected in the liquid crystal panels 100a and 100b with a vertical axis representing the number of rows of the scanning lines 12 from a first row to an mth row and a horizontal axis representing an elapsed time. In the figure, an example of a positive polarity writing period (+) in the unit period (OfL-R) is shown.

When the selection of the scanning lines 12 is indicated by a thick black line, the scanning lines 12 are exclusively selected row by row in each horizontal scanning period (1H), such that the selected scanning lines 12 are sequentially shifted from the first row to the mth row over time.

The positive polarity writing period (+) in the unit period (OfL-R) is followed by a negative polarity writing period (−). The scanning lines 12 are exclusively selected in order from the first row to the mth row in each horizontal scanning period (1H) similarly in the negative polarity writing period (−).

Further, although the unit period (OfL-R) in the odd-numbered field period (Odd-f) has been described herein, the scanning lines 12 are exclusively selected in each horizontal scanning period (1H) in order from the first row to the mth row similarly in the writing periods of the unit periods (OfL-G and OfL-B), and the unit periods (EfL-R, EfL-G, and EfL-B) in the even-numbered field period (Even-f).

FIG. 11 is a diagram illustrating which video pixels and at which projection positions the panel pixels a and b represent in the first embodiment. In detail, FIG. 11 is a diagram illustrating at what projection positions the four panel pixels a1 to a4 on the upper left side of FIG. 4 and the four panel pixels b1 to b4 on the upper right side of FIG. 4 represent the video pixels illustrated in FIG. 3 in the odd-numbered field period (Odd-f) and the even-numbered field period (Even-f).

As shown in the figure, in the odd-numbered field period (Odd-f), the panel pixels a1 to a4 represent the hatched video pixels A, A3, C1, and C3 in the odd-numbered row and the odd-numbered column in order. In other words, in the unit periods (OfL-R, OfL-G, and OfL-B) of the odd-numbered field period (Odd-f), the data signals of the R, G, and B components of the video pixels A1, A3, C1, and C3 are supplied to the panel pixels a1 to a4 in order, and the R, G, and B components are represented in order.

Further, in the odd-numbered field period (Odd-f), the panel pixels b1 to b4 represent the hatched video pixels A2, A4, C2, and C4 in the odd-numbered rows and the even-numbered columns in order. In other words, in the unit periods (OfL-R, OfL-G, and OfL-B) of the odd-numbered field period (Odd-f), the data signals of the R, G, and B components of the video pixels A2, A4, C2, and C4 are supplied to the panel pixels b1 to b4 in order, and the R, G, and B components are represented in order.

An arrow pointing to an upward direction in the panel pixel of the odd-numbered field period (Odd-f) indicates the shift direction from the projection position in the immediately preceding even-numbered field period (Even-f).

The processing circuit 21 controls the laser light sources 151R and 152R to on state in the unit period (OfL-R) of the odd-numbered field period (Odd-f). Thus, in the unit period (OfL-R), the R components of the video pixels A1, A3, C1, C3, A2, A4, C2, and C4 represented by the panel pixels a1 to a4 and b1 to b4 are visually recognized by the user. Next, the processing circuit 21 controls the laser light sources 151G and 152G to on state in the unit period (OfL-G). Thus, the G components of the video pixels A1, A3, C1, C3, A2, A4, C2, and C4 represented by the panel pixels a1 to a4 and b1 to b4 are visually recognized by the user.

The processing circuit 21 controls the laser light sources 151B and 152B to on state in the unit period (OfL-B). Thus, the B components of the video pixels A1, A3, C1, C3, A2, A4, C2, and C4 represented by the panel pixels a1 to a4 and b1 to b4 are visually recognized by the user.

In this manner, in the odd-numbered field period (Odd-f), the RGB components of the video pixels in the odd-numbered rows among the video pixels are represented in color sequence and are thus visually recognized in color by the user.

When the odd-numbered field period (Odd-f) ends, the even-numbered field period (Even-f) arrives. The processing circuit 21 controls the light path shift element 190 so that the projection position is shifted in a downward direction in the figure from the reference position by 0.5 pixels of the panel pixel.

In the even-numbered field period (Even-f), the panel pixels a1 to a4 represent the hatched video pixels B1, B3, D1, and D3 in the even-numbered rows and the odd-numbered columns in order. In other words, in the unit periods (EfL-R, EfL-G, and EfL-B) of the even-numbered field period (Even-f), the data signals of the R, G, and B components of the video pixels B1, B3, D1, and D3 are supplied to the panel pixels a1 to a4 in order, and the R, G, and B components are represented in order.

Further, in the even-numbered field period (Even-f), the panel pixels b1 to b4 represent the hatched video pixels B2, B4, D2, and D4 in the even-numbered rows and the even-numbered columns in order. In other words, in the unit periods (EfL-R, EfL-G, and EfL-B) of the even-numbered field period (Even-f), the data signals of the R, G, and B components of the video pixels B2, B4, D2, and D4 are supplied to the panel pixels b1 to b4 in order, and the R, G, and B components are represented in order.

An arrow pointing to the downward direction in the panel pixels in the even-numbered field period (Even-f) indicates a shift direction from the projection position in the immediately preceding odd-numbered field period (Odd-f).

The processing circuit 21 controls the laser light sources 151R and 152R so that the laser light sources 151R and 152R enter the on state in the unit period (EfL-R) of the even-numbered field period (Even-f). Therefore, in the unit period (EfL-R), the R components of the video pixels B1, B3, D1, D3, B2, B4, D2, and D4 represented by the panel pixels a1 to a4 and b1 to b4 are visually recognized by the user.

Next, the processing circuit 21 controls the laser light sources 151G and 152G so that the laser light sources 151G and 152G enter the on state in the unit period (EfL-G). Therefore, the G components of the video pixels B1, B3, D1, D3, B2, B4, D2, and D4 represented by the panel pixels a1 to a4 and b1 to b4 are visually recognized by the user.

The processing circuit 21 controls the laser light sources 151B and 152B so that the laser light sources 151B and 152B enter the on state in the unit period (EfL-B). Therefore, the B components of the video pixels B1, B3, D1, D3, B2, B4, D2, and D4 represented by the panel pixels a1 to a4 and b1 to b4 are visually recognized by the user.

In this manner, in the even-numbered field period (Even-f), the RGB components of the video pixels in the even-numbered rows among the video pixels are represented in color sequence, and thus are visually recognized in color by the user.

Thus, when viewed throughout the odd-numbered field period (Odd-f) and the even-numbered field period (Even-f), the video pixels arranged in (2m) rows and (2n) columns are visually recognized in color by the user with the composite image and the shift of the liquid crystal panels 100a and 100b.

As described above, in the embodiment, the arrangement of the panel pixels b needs to be shifted to the right direction in FIG. 4 by 0.5 pixels of the panel pixel with respect to the arrangement of the panel pixels a. In recent years, as the liquid crystal panel 100 has become smaller and higher resolution, the size of one side of the panel pixel is reduced to about several micrometers, for example. Significantly high positioning accuracy is required to set the liquid crystal panels 100a and 100b having such small-sized panel pixels to the relationship illustrated in FIG. 4.

To meet such a requirement, the projection display device 1 according to the embodiment is provided with the position adjustment element 195.

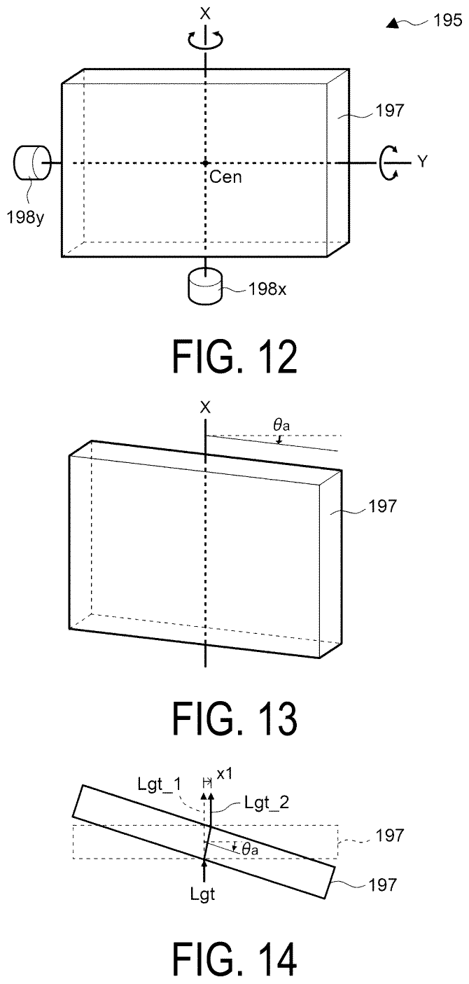

FIG. 12 is a diagram illustrating a configuration of the position adjustment element 195.

The position adjustment element 195 includes a refraction plate 197, and actuators 198x and 198y. The refraction plate 197 is a transparent, plate-shaped member with a refractive index of greater than 1.

The actuator 198x rotates the refraction plate 197 around the X axis in the direction and angle instructed by the processing circuit 21. The actuator 198y rotates the refraction plate 197 around the Y axis in the direction and angle instructed by the processing circuit 21.

The X axis is an axis that passes through a center Cen of the refraction plate 197, and is parallel to the short side of the transmission image of the liquid crystal panel 100b. The Y axis is an axis that passes through the center Cen, and is parallel to the long side of the transmission image of the liquid crystal panel 100b. When released from the control of the processing circuit 21, such as when the power is shut off, the refraction plate 197 is restored to the initial position. Preferably, the initial position of the refraction plate 197 is a position where the incident angle of the transmission image of the liquid crystal panel 100b with respect to the prism 180 is approximately zero.

Here, as illustrated in FIG. 13 a state where the refraction plate 197 is rotated clockwise by an angle 0a by the actuator 198x from the initial position indicated with the broken line as viewed from above the refraction plate 197 in the drawing is assumed.

FIG. 14 is a diagram for describing a shift of a transmission image by means of the position adjustment element 195.

When the refraction plate 197 is at the initial position indicated with the broken line, and light Lgt of the transmission image of the liquid crystal panel 100b impinges on the refraction plate 197 at an incident angle of zero degree, the light Lgt passes through the refraction plate 197 straight and is emitted as the light Lgt1.

On the other hand, when the refraction plate 197 rotates clockwise around the X axis by the angle Oa from the initial position, the light Lgt is refracted at the refraction plate 197, and emitted with a shift to the right direction by a distance x1 from the light Lgt1. In other words, the shift to the right direction by the distance x1 needs only to rotate the refraction plate 197 clockwise around the X axis by 0a.

Although not illustrated in the drawings, when the refraction plate 197 rotates counterclockwise from the initial position around the X axis, the light Lgt is refracted at the refraction plate 197 and emitted with a shift to the left direction from the light Lgt1. In addition, in FIG. 14, when the refraction plate 197 rotates clockwise as viewed from the right side, the light Lgt is shifted to the downward direction, whereas when the refraction plate 197 rotates counterclockwise, the light Lgt is shifted to the upward direction.

Next, the following describes position adjustment by means of the position adjustment element 195 for emitting the transmission image of the liquid crystal panel 100b onto the prism 180 in the initialization process.

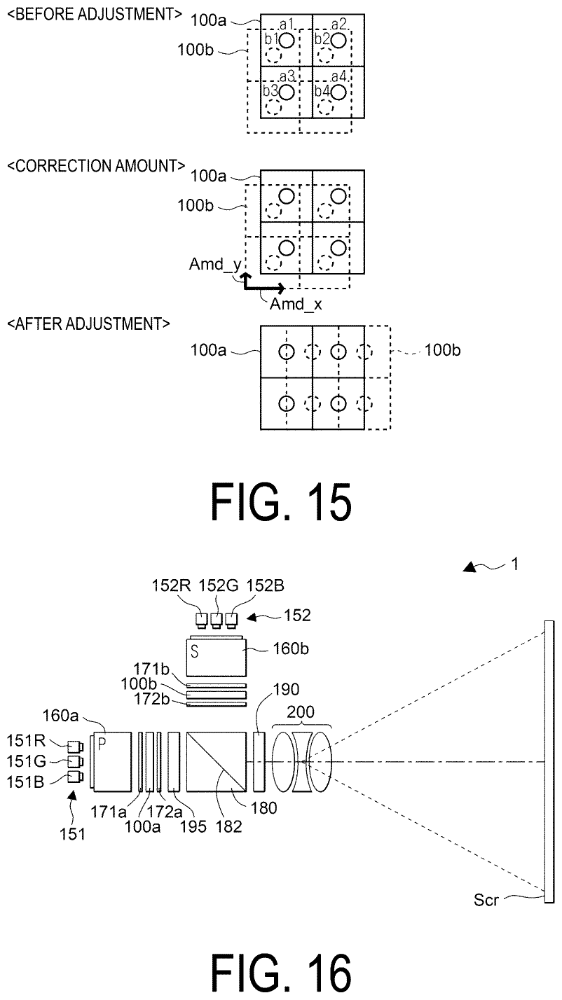

FIG. 15 is a diagram for describing position adjustment by means of the position adjustment element 195.

In the drawing, <before adjustment> is a diagram illustrating as a composite image of the prism 180 a state immediately after the liquid crystal panels 100a and 100b are assembled and fixed. This state is the initial state when the power is shut off, with a shift from the ideal state illustrated in FIG. 4.

In the drawing, <correction amount> is a value, divided into components in the horizontal direction and the vertical direction, of the shift amount required for shifting the transmission image of the liquid crystal panel 100b from the initial state position to the ideal state position. In the example illustrated in the drawing, it suffices to shift the transmission image of the liquid crystal panel 100b from the initial state position to the ideal state position by a distance Amd x in the right direction and by a distance Amd y in the upward direction.

The information representing the correction amount is obtained by actually operating the angle of the position adjustment element 195 until the ideal state is set from the state where the liquid crystal panels 100a and 100b are assembled, that is, the state where the position is shifted before shipment from the factory in the manufacturing process of the projection display device 1.

The obtained information representing the correction amount is stored in the memory element M of the processing circuit 21.

In the initialization process immediately after power-on, the processing circuit 21 reads the information representing the correction amount, and designates the rotational direction and rotation amount to the actuators 198x and 198y on the basis of the information.

With this designation the refraction plate 197 rotates, and the transmission image of the liquid crystal panel 100b is set to the ideal state position illustrated in <after adjustment> with respect to the transmission image of the liquid crystal panel 100a. This ideal state continues until the power is shut off, and when the power is shut off, the refraction plate 197 is restored to the initial position.

According to the embodiment, with the configuration in which the liquid crystal panels 100a and 100b are shifted in the vertical direction by 0.5 pixels of the panel pixel, the user can visually recognize a color image with a resolution four times higher than the resolution of the liquid crystal panels 100a and 100b. In other words, in the present embodiment, since it suffices to use the liquid crystal panels 100a and 100b having a resolution of ¼ of the resolution of the image to be visually recognized, the cost for the configuration can be reduced than using liquid crystal panels having the same resolution as projection images.

Further, according to the embodiment, the position of the transmission image of the liquid crystal panel 100b that is combined by the prism 180 is adjusted to the ideal state by the position adjustment element 195 with respect to the transmission image of the liquid crystal panel 100a. As a result, significantly high positional accuracy is not required for attaching the liquid crystal panels 100a and 100b, and thus the production efficiency of the projection display device 1 can be increased.

The above-described embodiment can be modified or applied in various ways as follows.

In the embodiment, the arrangement of the panel pixels b in the liquid crystal panel 100a is shifted in the right direction by only 0.5 pixels of the panel pixel with respect to the arrangement of the panel pixels b in the liquid crystal panel 100a, but the present disclosure is not limited thereto.

Although not illustrated in the drawings, a first modification has a configuration in which the arrangement of the panel pixels b is shifted to the downward direction by 0.5 pixels of the panel pixel with respect to the arrangement of the panel pixels a.

In the first modification, for example, the odd-numbered column of the video pixel is represented in the odd-numbered field period (Odd-f), and the even-numbered column of the video pixel is represented in the even-numbered field period (Even-f).

Further, in the first modification, the processing circuit 21 controls the light path shift element 190 as follows. The projection position in the odd-numbered field period (Odd-f) is set as a reference position. In the even-numbered field period (Even-f), the processing circuit 21 shifts the projection position in the right direction by 0.5 pixels of the panel pixel. When the even-numbered field period (Even-f) ends, the processing circuit 21 controls the light path shift element 190 so that the projection position is shifted in the left direction by 0.5 pixels of the panel pixel in the odd-numbered field period (Odd-f) and reset to the reference position. The right direction is the horizontal scanning direction, and is the direction from the panel pixel a1 to the panel pixel a2 in FIG. 4, for example.

In the embodiment, the position adjustment element 195 is provided between the polarization plate 172b and the prism 180, and the position adjustment element 195 adjusts the position of the transmission image of the liquid crystal panel 100b incident on the prism 180 with the transmission image of the liquid crystal panel 100a as a reference, but, the following second modification may also be employed.

FIG. 16 is a diagram illustrating a configuration of the projection display device 1 according to the second modification. In the second modification, the position adjustment element 195 is provided between the polarization plate 172a and the prism 180, and the position adjustment element 195 adjusts the position of the transmission image of the liquid crystal panel 100a incident on the prism 180 with the transmission image of the liquid crystal panel 100b as a reference.

In the configuration illustrated in FIG. 1 or FIG. 16, the transmission image of one of the liquid crystal panel 100a or 100b impinges on the prism 180 through the position adjustment element 195. In this configuration, even with the distance from the liquid crystal panel 100a to the prism 180 and the distance from the liquid crystal panel 100b to the prism 180 coinciding with each other, the light path length differs due to the passage through the position adjustment element 195. As a result, there is a risk of an influence such as out-of-focus on the composite image. In view of this, a third modification that reduces such an influence is described below.

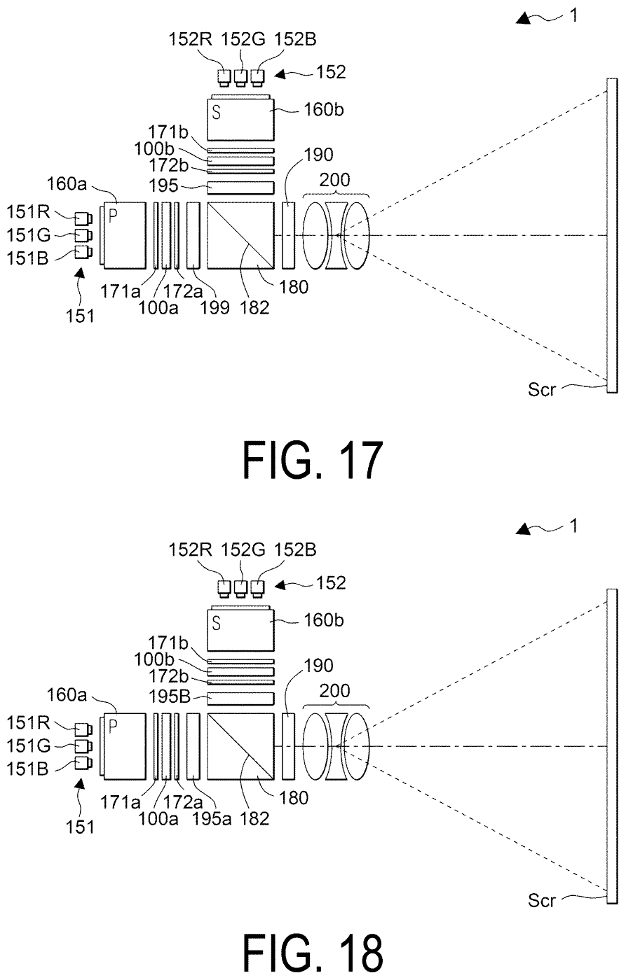

FIG. 17 is a diagram illustrating a configuration of the projection display device 1 according to the third modification. In the third modification, the position adjustment element 195 is provided between the liquid crystal panel 100b and the prism 180, and a light path length correction element 199 is provided between the liquid crystal panel 100a and the prism 180. Preferably, the product of the refractive index and the thickness is the same for the refraction plate 197 and the light path length correction element 199.

The third modification makes it easy to set the same light path length to the prism 180, and thus can suppress the influence of light path difference.

FIG. 18 is a diagram illustrating a configuration of the projection display device 1 according to the fourth modification. In the fourth modification, the position adjustment element 195a is provided between the liquid crystal panel 100a and the prism 180, and a position adjustment element 195b is provided between the liquid crystal panel 100b and the prism 180. In this configuration, the memory element M of the processing circuit 21 stores information representing the correction amount of the position adjustment element 195a, and information representing the correction amount of the position adjustment element 195b.

In the initialization process, the processing circuit 21 reads the information representing the correction amount of the position adjustment element 195a to control the shift of the position adjustment element 195a on the basis of the information, and reads the information representing the correction amount of the position adjustment element 195b to control the shift of the position adjustment element 195b on the basis of the information.

In the fourth modification, the influence of the light path difference can be suppressed without using the light path length correction element 199 in FIG. 17. In addition, in comparison with the configuration with only one of the position adjustment elements 195a and 195b, the position adjustment range can be increased.

In addition, in the fourth modification, it is possible to employ a configuration in which one of the position adjustment elements 195a and 195b shifts the light path in the left-right direction, and the other of the position adjustment elements 195a and 195b shifts the light path in the up-down direction, for example. With this configuration, the light path shift element 190 and the position adjustment element 195a and 195b can each perform the shift by one axis, which makes it possible to share the elements, and expect lower cost.

In the embodiment, the liquid crystal panels 100a and 100b serving as the image light emission devices are of the transmissive type, but the liquid crystal panels 100a and 100b may also be of a reflective type.

Further, in the embodiment, the liquid crystal panels 100a and 100b are configured to display colors in color sequence, but one panel pixel may be divided into RGB sub-pixels, and colors may be displayed by the three sub-pixels, for example. In this configuration, since one panel pixel has the RGB sub-pixels, it is possible to represent colors not without the color sequence, that is, without dividing one field period into three unit periods.

Further, the image light emission device is not limited to the liquid crystal panel 100, and a self-emitting display panel may be used. The self-emitting panel is a display panel that generates an image by emitting light from its own display elements, without using a light source like the liquid crystal panel 100. In the self-emitting panel, an organic light emitting diode (OLED), a micro light emitting diode (LED), or the like may be used as the display element.

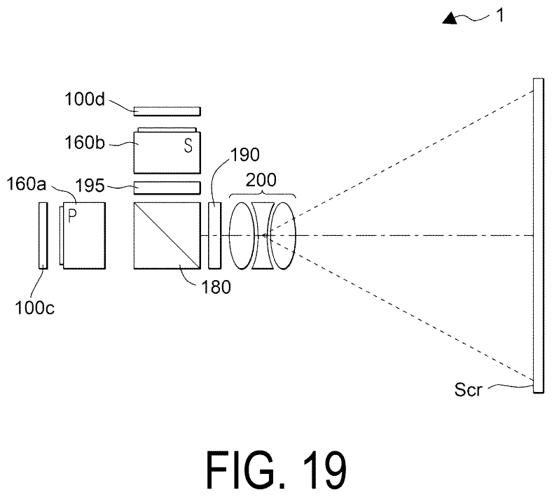

FIG. 19 is a diagram illustrating a configuration of the projection display device 1 according to the fifth modification. In the fifth modification, self-emitting panels 100c and 100d are used instead of the liquid crystal panels 100a and 100b.

The self-emitting panels 100c and 100d use OLEDs as the display element, for example. Both the self-emitting panels 100c and 100d have RGB sub-pixels, and make up one panel pixel using the RGB sub-pixels to represent color.

In the fifth modification, the arrangement of the panel pixels in the self-emitting panel 100c and the arrangement of the panel pixels in the self-emitting panel 100d are shifted in the horizontal direction (row direction) by 0.5 pixels of the panel pixel as in the embodiment.

Further, since the self-emitting panels have the RGB sub-pixels, it is possible to represent the color without dividing one field period into three unit periods, as described above.

Light emitted by the OLED is random light that is not polarized. As such, the optical polarization system 160a is provided between the self-emitting panel 100c and the prism 180, and the optical polarization system 160b is provided between the self-emitting panel 100d and the prism 180.

Further, as the image light emission device, it is also applicable to a mirror element in which the inclination of a mirror is set to a position corresponding to on or off, and reflects incident light in a predetermined direction only in one of the on and off states, for example.

In the embodiment and the first to fifth modifications, the odd-numbered field period (Odd-f) is an example of the first field period, and the even-numbered field period (Even-f) is an example of the second field period.

The position adjustment element 195 is an example of the first light path shift element, and the light path shift element 190 is an example of the second light path shift element. The position adjustment element 195a is an example of the first light path shift element, and the position adjustment element 195b is an example of the third light path shift element.

The transmission image of the liquid crystal panel 100b is an example of the first image light, the light source 152 is an example of the first light source, the R component is an example of the first color light component, the G component is an example of the second color light component, the B component is an example of the third color of light component, the S-polarized light is an example of the light first polarized light light, and the optical polarization system 160b is an example of the first polarization conversion member. Specifically, the device including the light source 152, the optical polarization system 160b, and the liquid crystal panel 100b is an example of the first image light emission device.

The transmission image of the liquid crystal panel 100a is an example of the second image light, the light source 151 is an example of the second light source, the P-polarized light is an example of the light second polarized light, and the optical polarization system 160a is an example of the second polarization conversion member. Specifically, the device including the light source 151, the optical polarization system 160a, and the liquid crystal panel 100a is an example of the second image light emission device.

The right direction is an example of the first direction, and the downward direction is an example of the second direction. The prism 180 is an example of the optical combination system.

The following aspects are derived from the above-described embodiments, for example.

A projection display device according to aspect 1 includes a first image light emission device configured to emit first image light, a second image light emission device configured to emit second image light, an optical combination system configured to combine, and emit as composite light, the first image light and the second image light in a state where the second image light is shifted in a first direction with respect to the first image light, a first light path shift element provided between the first image light emission device and the optical combination system, and configured to shift a light path of the first image light emitted from the first image light emission device, a second light path shift element configured to shift a light path of the composite light emitted from the optical combination system, and a display control circuit configured to control the first image light emission device, the second image light emission device, the first light path shift element, and the second light path shift element. Video pixel data making up video data is arranged along the first direction and a second direction intersecting the first direction, a one-frame period includes a first field period and a second field period, in the first field period, the display control circuit supplies to the first image light emission device a data signal of a video pixel that is odd-numbered in the second direction and is odd-numbered in the first direction in the arrangement, and supplies to the second image light emission device a data signal of a video pixel that is odd-numbered in the second direction and is even-numbered in the first direction in the arrangement, in the second field period, the display control circuit supplies to the first image light emission device a data signal of a video pixel that is even-numbered in the second direction and is odd-numbered in the first direction in the arrangement, and supplies to the second image light emission device a data signal of a video pixel that is even-numbered in the second direction and is even-numbered in the first direction in the arrangement, the display control circuit controls the second light path shift element to shift the light path in the second direction from a position of the first field, the first image light emission device emits the first image light based on supplied data signal, and the second image light emission device emits the second image light based on supplied data signal.

The projection display device according to aspect 1 can form high resolution projection at low cost, and further can increase the production efficiency of the projection display device.

In a projection display device of aspect 2 according to aspect 1, the first light path shift element is configured to shift the light path in the first direction or a first opposite direction opposite to the first direction, and the second direction or a second opposite direction opposite to the second direction, and the second light path shift element is configured to shift the light path in the second direction and the second opposite direction.

A projection display device of aspect 3 according to aspect 1 further includes a light path length correction element provided between the second image light emission device and the optical combination system.

A projection display device of aspect 4 according to aspect 1 further includes a third light path shift element provided between the second image light emission device and the optical combination system and configured to shift a light path of the second image light.

In a projection display device of aspect 5 according to aspect 1, the first image light emission device includes a first liquid crystal panel, a first light source configured to emit light toward the first liquid crystal panel, and a first polarization conversion member configured to convert the light emitted by the first light source into first polarized light, the first polarized light impinges on the first liquid crystal panel, the second image light emission device includes a second liquid crystal panel, a second light source configured to emit light toward the second liquid crystal panel, and a second polarization conversion member configured to convert the light emitted by the second light source into second polarized light, and the second polarized light impinges on the second liquid crystal panel.

In a projection display device of aspect 6 according to aspect 5, each of the first light source and the second light source is a laser light source configured to emit first light including a wavelength range of red, second light including a wavelength range of green, and third light including a wavelength range of blue.

In a projection display device of aspect 7 according to aspect 6, the first liquid crystal panel in the first image light emission device generates images of light components of a first color, a second color, and a third color in positive polarity writing and negative polarity writing, and the second liquid crystal panel in the second image light emission device generates the images of the light components of the first color, the second color, and the third color in positive polarity writing and negative polarity writing.

In a projection display device of aspect 8 according to any one of aspects 5 to 7, in the first field period and the second field period, the first image light emission device generates in a time-division manner a light component of a first color, a light component of a second color, and a light component of a third color having different wavelengths in the first image light, and the second image light emission device generates in a time-division manner a light component of the first color, a light component of the second color, and a light component of the third color in the second image light.

In a projection display device of aspect 9 according to aspect 1, the first image light emission device includes a first self-emitting panel including sub-pixels corresponding to a first color, a second color, and a third color having different wavelengths, and configured to emit the first image light, and a first polarization conversion member configured to convert light emitted from the first self-emitting panel into the first polarized light, and the second image light emission device includes a second self-emitting panel including sub-pixels of the first color, the second color, and the third color, and configured to emit the second image light, and a second polarization conversion member configured to convert light emitted from the second self-emitting panel into the second polarized light.

What is claimed is:

1. A projection display device comprising:
a first image light emission device configured to emit first image light;
a second image light emission device configured to emit second image light;
an optical combination system configured to combine, and emit as composite light, the first image light and the second image light in a state where the second image light is shifted in a first direction with respect to the first image light;
a first light path shift element provided between the first image light emission device and the optical combination system, and configured to shift a light path of the first image light emitted from the first image light emission device;
a second light path shift element configured to shift a light path of the composite light emitted from the optical combination system; and
a display control circuit configured to control the first image light emission device, the second image light emission device, the first light path shift element, and the second light path shift element, wherein
video pixel data making up video data is arranged along the first direction and a second direction intersecting the first direction,
a one-frame period includes a first field period and a second field period,
in the first field period, the display control circuit supplies to the first image light emission device a data signal of a video pixel that is odd-numbered in the second direction and is odd-numbered in the first direction in the arrangement, and supplies to the second image light emission device a data signal of a video pixel that is odd-numbered in the second direction and is even-numbered in the first direction in the arrangement,
in the second field period, the display control circuit supplies to the first image light emission device a data signal of a video pixel that is even-numbered in the second direction and is odd-numbered in the first direction in the arrangement, and supplies to the second image light emission device a data signal of a video pixel that is even-numbered in the second direction and is even-numbered in the first direction in the arrangement,
the display control circuit controls the second light path shift element to shift the light path in the second direction from a position of the first field,
the first image light emission device emits the first image light based on supplied data signal, and
the second image light emission device emits the second image light based on supplied data signal.

2. The projection display device according to claim 1, wherein
the first light path shift element is configured to shift the light path in the first direction or a first opposite direction opposite to the first direction, and the second direction or a second opposite direction opposite to the second direction, and
the second light path shift element is configured to shift the light path in the second direction and the second opposite direction.

3. The projection display device according to claim 1, further comprising a light path length correction element provided between the second image light emission device and the optical combination system.

4. The projection display device according to claim 1, further comprising a third light path shift element provided between the second image light emission device and the optical combination system and configured to shift a light path of the second image light.

5. The projection display device according to claim 1, wherein
the first image light emission device includes
a first liquid crystal panel,
a first light source configured to emit light toward the first liquid crystal panel, and
a first polarization conversion member configured to convert the light emitted by the first light source into first polarized light,
the first polarized light impinges on the first liquid crystal panel,
the second image light emission device includes
a second liquid crystal panel,
a second light source configured to emit light toward the second liquid crystal panel, and
a second polarization conversion member configured to convert the light emitted by the second light source into second polarized light, and
the second polarized light impinges on the second liquid crystal panel.

6. The projection display device according to claim 5, wherein each of the first light source and the second light source is a laser light source configured to emit first light including a wavelength range of red, second light including a wavelength range of green, and third light including a wavelength range of blue.

7. The projection display device according to claim 5, wherein
the first liquid crystal panel in the first image light emission device generates images of light components of a first color, a second color, and a third color in positive polarity writing and negative polarity writing, and
the second liquid crystal panel in the second image light emission device generates the images of the light components of the first color, the second color, and the third color in positive polarity writing and negative polarity writing.

8. The projection display device according to claim 5, wherein in the first field period and the second field period,
the first image light emission device generates in a time-division manner a light component of a first color, a light component of a second color, and a light component of a third color having different wavelengths in the first image light, and
the second image light emission device generates in a time-division manner a light component of the first color, a light component of the second color, and a light component of the third color in the second image light.

9. The projection display device according to claim 1, wherein
the first image light emission device includes a first self-emitting panel including sub-pixels corresponding to a first color, a second color, and a third color having different wavelengths, and configured to emit the first image light; and
a first polarization conversion member configured to convert light emitted from the first self-emitting panel into the first polarized light, and
the second image light emission device includes
a second self-emitting panel including sub-pixels of the first color, the second color, and the third color, and configured to emit the second image light; and
a second polarization conversion member configured to convert light emitted from the second self-emitting panel into the second polarized light.
